(19) United States
(12) Patent Application Publication
(10) Pub. No.: US 2008/0073422 A1
(43) Pub. Date: Mar. 27, 2008

(54) Method and system for tracking and managing cargo containers

(75) Inventor: Shouqin Zhou, Shenzhen (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: China International Marine Containers (Group) Ltd.

(21) Appl. No.: 11/828,742

(22) Filed: Jul. 26, 2007

(30) Foreign Application Priority Data
Jul. 26, 2006 (CN) 200610061871.X

(51) Int. Cl. G06F 17/00

(52) U.S. Cl. 235/375

(57) ABSTRACT

This application relates to a method and system for tracking and managing a cargo container. The system comprises an electronic seal device mounted on the cargo container, a portable device, a fixed device provided on sluice door, a guide device and a computer bound thereof, and a background management center system. The method and system for tracking and managing the cargo container according to the present invention can realize visible and transparent tracking, monitoring of any cargo container, such that risky and dangerous cargo containers can be effectively selected for a particular sampling inspection to ensure the shipment safety of the cargo container and realize the international antiterrorism of the cargo containers.

### CROSS-REFERENCE TO RELATED APPLICATION

This application is based on an application No. 200610061871.X filed in China, the content of which is hereby incorporated by reference.

### FIELD OF THE INVENTION

The present invention relates to cargo containers, and in particular, relates to method and system for tracking and managing cargo containers.

### BACKGROUND ART

Transportation security of cargo containers is an important issue in the field of cargo container supply chain, and includes preventing packages from falling, anti-theft, antiterrorism and so on. Nowadays, crimes of logistic fraud, theft and transfer of goods are happening everyday all over the world, most of which aim at cargo containers.

A traditional mechanical lead seal is widely used as a typical customs seal of a cargo container, and is very popular in the industry of cargo container transportation. The mechanical lead seal applies bolt fixed lead seal structure to lock the closure of a cargo container, indicates the integrity of the lead seal with a number of lead seal printed on the lead seal, and is ruinously unlocked by an common wire cutter, which is easy for both receivers and larceners. Therefore, the mechanical lead seal is not sufficient to prevent theft of cargo containers. Another typical customs seal of a cargo container widely used is a reinforced mechanical lead seal, which applies iron bars with certain strength to lock the two lock rods of the cargo container, and needs to be cut off with an electrical saw at the time of unlocking. This makes it hard to steal, but it is not a difficulty if the larceners have an electrical saw. Furthermore, it is one use disposable and expensive, so it is hard to get widely used.

Although mechanical seals are mainstream in nowadays, electronic seal devices are getting popular progressively. An electronic seal device is driven by battery, can be made in a shape of sensor bolt, or can be made as an intelligent seal implanted into RFID tag, for which the operation distance of the portable and fixed read-write device may reach 10 meters and 30 meters respectively, and its operational frequency applies 2.4 GHz, which ensures the application all over the world against time. The electronic seal device and relevant device can be applied not only in locking the cargo containers, but also monitoring the unlocking history of the locked cargo containers. After the cargo containers being loaded and sealed by the seal, the shipping agent encrypts the cargo container with a unique encrypted code. Once the cargo container enters a wireless reading device globally distributed, which is similar to a normal electronic toll system of highway, the device can report logistic chain, the status of the cargo containers, the arrival of the cargo containers and illegal unlocking issue on the way. The above information can provide data to producers, customs and importer to judge if the security of a certain cargo container in the supply chain is threatened.

China patent application CN200480008731.5 discloses a continuous feedback type cargo container security system, wherein security devices include a housing and an supporting rack on the house, which is provided for being mounted on the device to be secured, and comprises a switch. The switch is configured to generate a first indication when the supporting rack is mounted on the device to be secured and to generate a second indication when the supporting rack is removed from the device to be secured. An power supply, a transceiver and an electronic circuit provided inside the housing are connected to each other, wherein the power supply is connected to the switch, and the transceiver is configured to communicate with a monitoring device. When the first indication is generated, the electronic circuit turns into an alarm status and enables the transceiver to transmit OK signal periodically to the monitoring device in case there was not at least one of a plurality of alarm issues. China patent application CN03825176.0 discloses a method and system for monitoring a cargo container to maintain its security, the system comprises an apparatus, a reader, a server and a software center. The apparatus communicates with the reader to determine the security and/or location of the cargo containers, and the apparatus is attached to the cargo container. The reader transmits information from the apparatus to the server. The apparatus judges whether a security issue occurs based on at least one sensor on or in the cargo container. China patent application CN200420037164.3 discloses an electronic tag device of a cargo container. The device includes an electronic tag, a read-write device and an antenna, wherein said electronic tag are provided on the surface of the cargo container, and said read-write device and antenna are formed as a whole, or are separately mounted on a transfer channel or a swing device of the cargo container, respectively.

### SUMMARY OF THE INVENTION

An aspect of the present invention is to overcome the deficiencies of the prior art, and realize visible and transparent tracking, monitoring of any cargo container, such that risky and dangerous cargo containers can be effectively selected for a particular sampling inspection to ensure the shipment safety of the cargo container and realize the international antiterrorism of the cargo containers.

In order to realize the above aspect, the present invention provides a method for tracking and managing a cargo container comprising:

providing an electronic seal device within a closure of the cargo container;

providing at least one portable device for reading and writing the electronic seal device;

providing at least one fixed device for reading and writing the electronic seal device;

providing at least one server for communicating with the portable device and fixed device;

providing a management center for communicating with the server to manage the electronic seal device, the portable device, the fixed device, and user information, wherein the management center comprises a registration and authentication portion and a database portion;

the portable device and fixed device obtaining a seal code from the management center, after passing authentication;

the cargo container sealing the electronic seal device provided in the cargo container with a defined sealing code, after goods are loaded and the closure of the cargo container is closed and after defined information is input through the portable device and/or fixed device, then uploading the sealing code and the defined information to the management center through the server to activate the electronic seal device; and

the cargo container unsealing the electronic seal device of the cargo container through the portable device and/or fixed device when the portable device and/or fixed device pass authentication, after the cargo container arrives at a destination, communicating with the management center via the server through the portable device and/or fixed device, and canceling the sealing code in use to notify the management center that a logistic shipment is accomplished.

On the other hand, in order to realize the aspect of the present invention, the present invention also constitutes a system for tracking and managing a cargo container, comprising:

an electronic seal device comprising a sensor unit, a low frequency wake-up antenna, a high frequency data transceiver antenna, a signal process unit and a power supply;

at least one portable device for reading and writing the electronic seal device, comprising a low frequency wake-up antenna for waking up the electronic seal and a high frequency data transmission antenna for performing a communication session with the electronic seal device and performing data transmission;

at least one fixed device for reading and writing the electronic seal device, comprising a guide device and a high frequency data transceiver antenna for performing a communication session with the electronic seal device and performing data transmission, wherein the guide device is provided with a low frequency wake-up antenna for waking up the electronic seal;

at least one server comprising at least one computer for communicating with the portable device and the fixed device;

a management center comprising at least one computer for communicating with the server to manage the electronic seal device, the portable device, the fixed device and user information, wherein the management center comprises a registration and authentication portion and a database portion;

wherein the portable device and the fixed device obtains a sealing code from the management center, after passing authentication;

the cargo container seals the electronic seal device provided in the cargo container with a defined sealing code, after goods are loaded and a closure of the cargo container is closed and after defined information is input through the portable device and/or fixed device, then the sealing code and the defined information are uploaded to the management center through the server to activate the electronic seal device;

after the cargo container arrives at a destination, the cargo container unseals the electronic seal device of the cargo container through the portable device and/or fixed device when the portable device and/or fixed device pass authentication, then performs communication session with the management center via the server through the portable device and/or fixed device, and cancels the sealing code in use to notify the management center that a logistic shipment is accomplished.

As compared with the prior art, the method and system for tracking and managing the cargo container according to the present invention can realize point to point tracking during the whole logistic procedure, the tracking and managing of relevant information, such as location and status of the cargo containers, and enable logistic information of the cargo containers being real-time and transparent. Furthermore, the safety of the cargo containers during the shipment can be tracked by tracking information of the electronic seal device of the cargo container in the whole logistic chain, such that the safety of the goods transportation can be ensured and the international antiterrorism of the cargo containers may be realized.

### BRIEF DESCRIPTION OF THE DRAWINGS

FIG. 1 is a diagram showing the network structure of the system for tracking and managing a cargo container according to the present invention;

FIG. 2 is flowchart showing the data flow of the system for tracking and managing the cargo container according to the present invention;

FIG. 3 is a diagram showing an electronic seal device of the system for tracking and managing the cargo container according to the present invention; and

FIG. 4 is a flowchart showing the information and management of the system for tracking and managing the cargo container according to the present invention.

### DETAILED DESCRIPTION OF THE PREFERRED EMBODIMENTS OF THE INVENTION

The embodiments of the present invention will be further described in detail with reference to the drawings hereinafter.

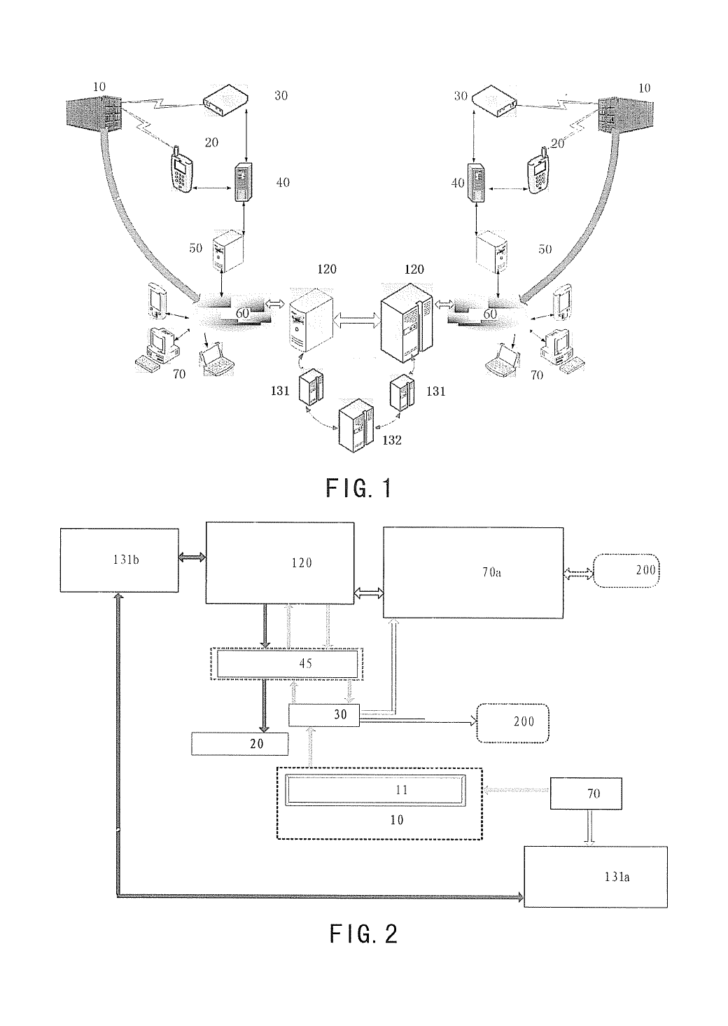

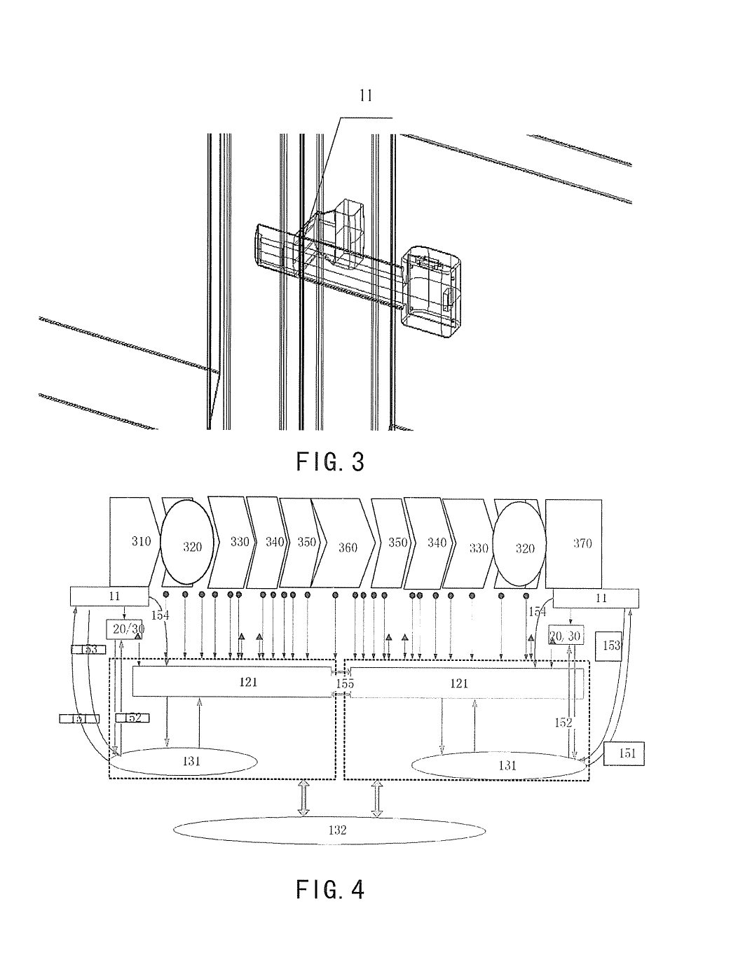

As show in FIG. 3, in the system for tracking and managing the cargo container according to one embodiment of the present invention, an electronic seal device 11 is provided within a closure of the cargo container. As shown in FIG. 1, the system for tracking and managing the cargo container according to the present invention comprises cargo containers 10 provided with an electronic tag and an electronic seal device (not shown), portable devices 20, fixed devices (i.e., readers) 30 provided at a sluice, site servers 40 provided at a harbor, region servers 50 provided in the central cities of the region, and a management center provided globally, which comprises two or more system management and operation data centers 120, two or more national registration and authentication centers 131, and a global registration and authentication center 132. The portable device 20 and/or the fixed device 30 follow the protocol of ISO 18000-6 or ISO18000-7 to wirelessly communicate with the electronic tag and the electronic seal device, the portable device 20 follows 802.11 protocol or GPRS protocol to wirelessly communicate with the site server 40, the fixed device 30 follows 802.11 protocol, TCP/IP protocol or RS232/485 protocol to communicate with the site server 40, the site server 40 follows 802.11 protocol, TCP/IP protocol or WLAN protocol to communicate with the region server 50, and the region server 50 follows TCP/IP protocol to communicate with the management center through Internet 60. Users 70 can contact with the region server 50 and/or the management center via Internet 60 by using of terminal devices. The left half portion of the figure may be considered as the configuration of the export side, and the right half portion of the figure may be considered as the configuration of the import side. For example, one side stands for China, the other side stands for the US, and one system management and operation data center 120 is provided for each side of China and US, and national registration and authentication centers 131 are provided similarly.

The electronic seal device comprises a sensing unit, a low frequency wake-up antenna, a high frequency data transceiver antenna, a signal process unit and a power supply. Guide devices in the portable device 20 and fixed device 30 transmit signals to the low frequency wake-up antenna of the electronic seal device to wake up the electronic seal device, then the data of the electronic seal device is transmitted to the portable device 20 and fixed device 30 through the high frequency data transceiver antenna, and the portable device 20 and fixed device 30 upload the data to the site server 40.

As shown in FIG. 2, the data flow of the system for tracking and managing the cargo container according to the present invention comprises: a user/shipper 70 registers with the user registration center 131a; the user/shipper 70 seals the electronic seal device 11 with the portable device 20/fixed device 30 when the cargo container 10 is ready and operation situation is normal; the data of the electronic seal device 11 can be read by the reader 30, then transmitted to an external system 200, or can communicate with the system management and operation data center 120 through communication module 45 within the site server 40/region server 50, and the system management and operation data center 120 transmits a sealing password to the portable device 20/fixed device 30 through the communication module 45 provided within the server, wherein between an authentication center 131b and a user registration center 131a, between the authentication center 131b and the system management and operation data center 120, between the system management and operation data center 120 and the user system 70a, as well as between the user system 70a and external system 200, there exist information exchanges, the user system 70a may be the software installed on the computer of the user 70, and the user registration center 131a together with the authentication center 131b may constitute the national registration and authentication center 131.

As shown in FIG. 4, the process of the system for tracking and managing the cargo container comprises registration and authentication management of the devices, registration and authentication of the users, information management of the data center, and sealing, unsealing, activation, cancellation of cargo containers. Hardware devices such as the electronic seal device 11, portable device 20 and fixed device 30 should be registered and authenticated by registration and authentication center 131 before coming into use. The exchange of registration and authentication between the region registration and authentication centers 131 is performed by the international registration and authentication center 132. The region management center is provided with regional data centers 121, between which data exchange 155 can be directly performed. The identifications of users 70 of portable device 20 and fixed device 30 and system users are both granted by the management center with registration. The sealing and unsealing operation process of the cargo container electronic seal device 11 comprises sealing, unsealing, activation and cancellation. In particular, after passing through identification authentication process 152, a legal user 70 purchases sealing code from the management center via the portable devices 20 and fixed devices 30, which have been registered and authenticated, wherein the purchase comprises requesting process 153 and issuing sealing code process 151. A shipper 310 or shipping agent/land carrier 320 transfers goods from goods yard 330 to customs 340, and after inspection, the goods are located in dock 350. After the goods are loaded into the cargo container, the closures of the cargo container are closed, and the cargo containers are sealed with a sealing code after input of relevant information to portable device 20. After the above sealing is performed, the sealing code and the relevant information will be transmitted to the management center to accomplish activation process 154. After transported to the destination dock 350 by a waterway carrier 360, the cargo containers are transferred to the customs 340, and are located in a goods yard/bonded warehouse 330 after the inspection, then a shipping agent/land carrier 320 transfers the goods from the goods yard/bonded warehouse 330 to consignee 370, which unseals the cargo container electronic seal device 11 with portable device 20 and fixed device 30 through the identification authentication process 152. After unsealing, the portable device 20 and fixed device 30 communicate with the management center to perform the cancellation, and notify the management center that the present logistic process has accomplished. The black points in FIG. 4 represent the collecting points of tracking data. Therefore, the whole procedure of the shipment is under the monitoring of the system for tracking and managing the cargo container, and the data is stored into the region data center 121.

One embodiment of the method and system for tracking and managing cargo containers is designed in accordance with the provisions of Green Pass for international electronic logistic. The work process of the system can be classified into an operation process for common users and an operation process for customs users, and can be mainly constituted by a sealing operation, an unsealing operation and a search operation.

Operation Process for Common Users

The detailed sealing operation is as follows:

1. A user operates the watchman software installed in the portable device, and gets access to the software system of the portable device through the user ID and password registered in the management center. All the electronic seal devices within the effective communication range are read, or actually scanned. And if a plurality of electronic seal devices are read out, the electronic seal device to be operated is selected from a list of the plurality of electronic seal devices. Alternatively, the electronic seal device is selected by recognizing a cargo container ID with unaided eyes since an electronic seal device is correlative to a cargo container ID (identification). Then through the selection, an operation interface is entered under the condition of confirmation for, the operation authority, and memory information of the electronic seal device is read. If it is determined to seal the electronic seal device, the electronic seal device is sealed through sealing interface of the electronic seal device in the operation interface.

2. If it is read that the electronic seal device is sealed, then it should be unsealed at first, otherwise it cannot be sealed. If the electronic seal device is unsealed, then it can be sealed directly

3. In the unsealing operation, first, user information and event record are automatically removed from the unsealed electronic seal device.

4. When the user enters the sealing interface of the electronic seal device through the operation interface, fills in “cargo container number”, “mechanical seal number”, “packing list”, then “consigner code” is loaded automatically. As a result, the electronic seal device ID and filled information are bound, and five critical basic information of a voyage is bound.

5. Sealing operation is performed. First, before sealing, it should be assured that portable device is provided with a sealing code, which should be a single sealing code for each voyage since the sealing code functions as an electronic key and a charge credential during the whole electronic logistic. The User visits the website of the management center through GPRS or Internet with portable device or fixed device, purchases several (indefinite) sealing codes from the management center with the registered user ID and downloads them to a local sealing code database, which means the user has a deposit in the account of the registration management center, and each time the user purchases sealing codes, the expenses will be charged from the account according to the number of the sealing codes, or the user can also monthly pay for the expenses. After accomplishing the binding operation in operation 4, the sealing is performed. The user clicks an operation button of “sealing” to activate the electronic seal device system, meanwhile the history record is removed automatically, and the electronic seal device ID is bound with the critical basic information as mentioned above, which is stored in the electronic seal devices, that is, in the data storage.

6. Then, activation is performed. Since the so-called “sealing” refers to the sealing process for the electronic seal device, wherein the communications are merely performed between the electronic seal device and the portable or fixed device, the final information does not enter the database of the management center. And when the sealed electronic seal device enters the reading area of the fixed device in the monitoring spot, even if the device reads out the electronic seal device information, it still cannot write the relevant information into the database of the management center. As a result, the relevant information of sealed electronic seal device and correlated cargo container thereof cannot be searched out from the database of the management center. Therefore, it is necessary to activate the sealed electronic seal device. So-called “activate” refers to, through wireless GPRS or Internet network, binding the sealing information with sealing code, and writing the bound result into the database of the management center which will return acknowledge information. Accordingly, this is also the reason why the user purchases the sealing code in advance. If there is no code, it is impossible to find a writing location in the database of the management center. Thereby, once the electronic seal device is “activated”, it means that the electronic seal device enters the database of the management center to monitor therein. Meanwhile, the activated sealing codes are removed from the operation device of the user, and inactivated sealing codes are still valid. Then, the whole sealing process is accomplished.

7. The above operations are based on GPRS or Internet. For the cases without the network base, the sealing process is as follows:

A. First, “Pre-sealing” operation is performed on field through a removable plug provided for the sealing electronic seal device, which corresponds to a starting device of the electronic seal device. After the goods were loaded, an operator inserts and draws the plug for one time, and closes the cargo container immediately. Then, 30 seconds later, the electronic seal device is initiated automatically, detecting of the status of the cargo container closure is started, and an alert status is entered.

B. Once the cargo container enters a spot with the network infrastructures and sealing device, the sealing device reads the status of the electronic seal device. And if there is no alert, the sealing operation and activation operation are performed automatically according to the electronic seal device ID. That is, “cargo container number”, “mechanical seal number”, “packing list” and “consigner code”, which have been input into the database of the fixed device as four principle basic information, are written into the electronic seal device, and the sealing information and sealing code are bound and written into the database of the management center by the fixed device automatically at the sluice.

8. The sealing and activation of the electronic seal devices are realized. The sealing is processed one by one for the cargo containers, as well as the activation. Alternatively, the cargo containers can be activated uniformly by the fixed device. If the “pre-sealed” electronic seal device is only sealed without being activated separately when passing the sluice, the activation can be performed uniformly, that is, the binding information is stored in the fixed device while bound with the sealing code, then is activated uniformly while the sealing code is removed from the device. Therefore, the whole cargo container logistic process can be monitored, and the cargo containers will be tracked and monitored for the whole shipment by the global central management center. The detailed unsealing operation is as follows:

1. A user operates the watchman software installed in the portable device, and enters the portable device system with user ID and password, reads the electronic seal device information, and the unsealing operation is performed after the information is confirmed.

2. Unsealing operation is performed. Users click “unsealing” operation button, and the electronic seal device stops alert, that is, stops the work of the detecting portion of the sensor, such that the cargo container can be opened physically, and the goods can be unloaded by the consignee as usual.

3. After successful unsealing, all the information of the electronic seal device cannot be removed unless by clicking “cancellation” button, or it can be removed before sealing in a case of the next sealing. After unsealing, the central management database memorizes all the relevant information and records of the whole shipment corresponding to the electronic seal device ID, and only after a new shipment begins, and the sealing and activation are performed once again, new shipment records will replace the previous shipment records.

The detailed search operation is as follows:

1. Local Search

A User operates the watchman software installed in the portable device, and gets access to the software system of the portable device through the user ID and password. All the electronic seal devices within an effective communication range are read (scanned). And if a plurality of electronic seal devices are read out, the electronic seal device to be operated is selected from a list of the plurality of electronic seal devices. Then through the selection, an operation interface is entered, and memory information of the electronic seal device is read. After confirmed by the electronic seal device, all the stored information will be sent to the portable or fixed device directly, and then “search” button is clicked to perform relevant information search.

2. Network Search

A user visits website of management center through GPRS or Internet, and logs in the database of the management center with registered user name, then searches the information relevant to the cargo containers and logistic through search function according to the cargo container number or electronic seal device ID.

Operation Process for a Customs User

Customs is a monitor department of the government. The process of sealing, unsealing and search performed by customs user is basically the same as that performed by the common user except for some specific points hereinafter.

1. The customs user has special authority, with which the customs user can seal, unseal and search any electronic seal device.

2. During the search performed by the customs user, if there is a suspect cargo container, all the search information will be saved automatically, and uploaded to the database of the management center through GPRS or Internet.

3. After the customs user unseals or re-seals the electronic seal device, unlike the common users, who have the authority to remove the information in the memory of the unsealed electronic seal device, the customs user will archive the unsealing and re-sealing event in the memory of the electronic seal device.

4. When it is re-sealed after the unsealing, since the mechanical seal has been destroyed by the customs to physically open the cargo container, a new mechanical seal will be provided when the cargo container is closed physically again. Thereby, it is necessary to re-fill “mechanical seal number”, which is the only one item to be changed.

5. After the unsealing or re-sealing is accomplished by the customs, the cancellation or activation does not need to be performed. Since the electronic seal device has been activated in the database of the management center, and the shipment is not finished, the status of the electronic seal device read by the fixed device in the monitoring spot must be the status of sealing. And if it is unsealing status, which corresponds to that the shipment of the cargo container is not finished but the cargo container is unsealed to escape from monitoring, the alarm will run.

The function of portable or fixed device of the customs user and that of the common user are the same, except that if the customs user logs in with the user name and password, some functions, such as canceling, activating, filling in cargo container ID and so on, are blocked, which ensures that the operations of the customs staff are safe and reliable.

The above merely illustrates preferable embodiments according to the present invention, which should not limit the implementations of the present invention. It should be understood that numerous modifications and alternations can be made by a person skilled in the art without departing from the spirit and principle of the present invention, and the protection scope of the present invention should be defined by the appended claims.

What is claimed is:

1. A method for tracking and managing a cargo container comprising:
providing an electronic seal device within a closure of the cargo container;
providing at least one portable device for reading and writing the electronic seal device;
providing at least one fixed device for reading and writing the electronic seal device;
providing at least one server for communicating with the portable device and fixed device;
providing a management center for communicating with the server to manage the electronic seal device, the portable device, the fixed device, and user information, wherein the management center comprises a registration and authentication portion and a database portion;
the portable device and fixed device obtaining a seal code from the management center, after passing authentication;
the cargo container sealing the electronic seal device provided in the cargo container with a defined sealing code, after goods are loaded and the closure of the cargo container is closed and after defined information is input through the portable device and/or fixed device, then uploading the sealing code and the defined information to the management center through the server to activate the electronic seal device; and
the cargo container unsealing the electronic seal device of the cargo container through the portable device and/or fixed device when the portable device and/or fixed device pass authentication, after the cargo container arrives at a destination, communicating with the management center via the server through the portable device and/or fixed device, and canceling the sealing code in use to notify the management center that a logistic shipment is accomplished.

2. The method according to claim 1, wherein the process of sealing the electronic seal device provided in the cargo container with the defined sealing code after the goods are loaded and the closure of the cargo container is closed and after defined information is input through the portable device and/or fixed device, comprises following steps of:
a. getting access to a software system of the portable device through a user name and a password registered in the management center by a user;
b. capturing all electronic seal devices within an effective communication range, and if a plurality of electronic seal devices are captured, selecting an electronic seal device to be operated from a list of the plurality of electronic seal device, or selecting the electronic seal device by recognizing a cargo container ID with unaided eyes;
c. reading memory information of the electronic seal device, if it is read that the electronic seal device is sealed, then unsealing it first otherwise it cannot be sealed, and if the electronic seal device is unsealed, it can be sealed;
d. removing all user information and event record automatically from the unsealed electronic seal device;
e. filling in “cargo container number”, “mechanical seal number”, and “packing list” by operating the portable device, and automatically loading “consigner code” stored in the portable device; and
f. activating the electronic seal device and meanwhile removing the history record automatically, and binding ID of the electronic seal device with the filled information by operating the portable device.

3. The method according to claim 2, wherein the process of uploading the sealing code and the defined information to the management center through the server to activate the electronic seal device, comprises following steps of:
a. binding the sealing information and the sealing code, and writing the bound result into the database portion of the management center;
b. returning an acknowledge by the database portion of the management center; and
c. removing activated sealing codes from the device operated by the user.

4. The method according to claim 1, wherein the process of sealing the electronic seal device provided in the cargo container with the defined sealing code after the goods are loaded and the closure of the cargo container is closed and after defined information is input through the portable device and/or fixed device, comprises following steps of:
a. providing a startup device of the electronic seal device in a spot where the portable device and/or fixed device is not provided, closing the closure of the cargo container immediately after the goods are loaded by operating the startup device, automatically initiating the electronic seal device after a defined period elapses, and starting to detect a status of the closure of the cargo container and entering an alert status; and
b. When the cargo container enters a spot where a fixed device is provided, reading a status of the electronic seal device by the fixed device, and if there is no alert, then automatically sealing the electronic seal device according to the ID of the electronic seal device, that is, writing “cargo container number”, “mechanical seal number”, “packing list” and “consigner code” into the electronic seal device automatically by the fixed device.

5. The method according to claim 4, wherein the process of uploading the sealing code and the defined information to the management center through the server to activate the electronic seal device, comprises following steps of:
a. binding the sealing information and the sealing code, and writing the result into the database portion of the management center;
b. returning an acknowledge by the database portion of the management center; and
c. removing activated sealing codes from the fixed device operated by the user.

6. The method according to claim 1, wherein the process of unsealing the electronic seal device of the cargo container through the portable device and/or fixed device when passing the authentication, after the cargo container arrives at the destination, comprises following steps of:
a. entering a software system of the portable device with a user name and a password registered in the management center by a user; and
b. reading information of the electronic seal device, and after the information is confirmed, stopping work of the electronic seal device by the user operating the portable device.

7. A system for tracking and managing a cargo container, comprising:
an electronic seal device comprising a sensor unit, a low frequency wake-up antenna, a high frequency data transceiver antenna, a signal process unit and a power supply;
at least one portable device for reading and writing the electronic seal device, comprising a low frequency wake-up antenna for waking up the electronic seal and a high frequency data transmission antenna for performing a communication session with the electronic seal device and performing data transmission;
at least one fixed device for reading and writing the electronic seal device, comprising a guide device and a high frequency data transceiver antenna for performing a communication session with the electronic seal device and performing data transmission, wherein the guide device is provided with a low frequency wake-up antenna for waking up the electronic seal;
at least one server comprising at least one computer for communicating with the portable device and the fixed device;
a management center comprising at least one computer for communicating with the server to manage the electronic seal device, the portable device, the fixed device and user information, wherein the management center comprises a registration and authentication portion and a database portion;
wherein the portable device and the fixed device obtains a sealing code from the management center, after passing authentication;
the cargo container seals the electronic seal device provided in the cargo container with a defined sealing code, after goods are loaded and a closure of the cargo container is closed and after defined information is input through the portable device and/or fixed device, then the sealing code and the defined information are uploaded to the management center through the server to activate the electronic seal device;
after the cargo container arrives at a destination, the cargo container unseals the electronic seal device of the cargo container through the portable device and/or fixed device when the portable device and/or fixed device pass authentication, then performs communication session with the management center via the server through the portable device and/or fixed device, and cancels the sealing code in use to notify the management center that a logistic shipment is accomplished.

8. The system according to claim 7, further comprises a startup device of the electronic seal device for closing an closure of the cargo container immediately after the goods are loaded by a user operating the startup device, automatically initiating the electronic seal device after a defined period elapses, and starting to detect a status of the cargo container closure and entering an alert status.

9. The system according to claim 7, wherein the portable device is held by a consigner, a consignee and/or staff of customs.

10. The system according to claim 7, wherein the fixed device is provided at a sluice gate of a harbor, and the server is provided at the harbor.
